(19) United States
(12) Patent Application Publication
(10) Pub. No.: US 2006/0184932 A1
(43) Pub. Date: Aug. 17, 2006

(54) Method and apparatus for identifying and cataloging software assets

(75) Inventors: Christopher O. Burnley, Daly City, CA (US); Jian Shen, East Palo Alto, CA (US); Brian Gerhold, Cupertino, CA (US); John Ling, San Jose, CA (US)

Correspondence Address: RAYMOND R. MOSER JR., ESQ.;MOSER IP LAW GROUP, 1040 BROAD STREET, 2ND FLOOR, SHREWSBURY, NJ, 07702, US

(73) Assignee: Blazent, Inc.

(21) Appl. No.: 11/057,647

(22) Filed: Feb. 14, 2005

(51) Int. Cl. G06F 9/445

(52) U.S. Cl. 717/174

(57) ABSTRACT

A method and apparatus are disclosed for identifying and cataloging software assets contained on a networked computer. In accordance with one embodiment, there is provided a method comprising providing a data warehouse including a master catalog file. The master catalog file comprises a software items table of attributes, a software packages table of attributes, and a mapping rules table for mapping certain software item entries to certain software package entries.

### BACKGROUND OF THE INVENTION

1. Field of the Invention

Embodiments of the present invention generally relate to a content management system, and more particularly, to a method and apparatus for identifying and cataloging software assets.

2. Description of the Related Art

Certain enterprises or organizations use server-based computer networks to collect, store and manage data relating to that enterprise or organization. A typical server-based computer network generally comprises a plurality of interconnected computers, which, in turn, are connected to at least one computer server via a data communications network. The server commonly includes memory storage devices for storing data, as well as, operating system (OS) and application software elements for controlling, collecting and managing the data.

While networked computer systems provide known advantages and address most of an organization's information technology (IT) needs, the ever increasing number and diversity of software assets installed on networked client computers or “machines” is making it difficult for organizations to inventory and manage such network resources. For example, an organization may need information regarding all software assets installed on each client computer and whether such assets have been properly licensed. Or, an organization may need to know whether it is utilizing certain software assets to the fullest extent possible under the terms of a current license agreement.

In an attempt to inventory and manage these software assets, IT managers may employ some form of “extract, transform, load” (“ETL”) application software in an attempt to maintain an up-to-date inventory file of the software assets. For example, known systems analyze header information for each executable file on each client computer to determine what has been installed. This necessitates the need to analyze voluminous amounts and duplicative data for many networked computers.

Other known systems generate a list of properties for each software executable file installed on a client computer. Such properties typically include only the file name and file size of each software executable file. The collected information then may be compared to a software audit file. The software audit file provides identifying information limited to file name and corresponding file size, for each known software file. This method, however, requires each and every software executable file installed on a client computer to be collected and compared to known information in the audit file to determine which software assets have been installed on each client computer. This linear, one-to-one comparison is time-consuming and cumbersome at best. In addition, these systems are not flexible in that if a complete match does not occur between the collected file and the audit file, the software asset in question cannot be identified.

In addition to the above limitations, none of these known approaches effectively determine whether certain software packages, e.g., MICROSOFT (MS) OFFICE or MS OFFICE PROFESSIONAL (MS OFFICE PRO), are installed on a client computer or machine. Rather, known systems gather information on the software executable file level (e.g., whether WINWORD.EXE is installed) and those that may search for software packages laboriously and linearly match a relatively large number of software executable files to a software package in an attempt to identity the software package contained on a given computer.

Although software file information is important, software package information (e.g., whether MS OFFICE or MS OFFICE PRO is installed) is generally more valuable to an organization because it can more readily identify and assess licensable software assets. Furthermore, an organization is able to manage compliance or optimization issues with an inventory of software packages like MS OFFICE rather than software executable files like WINWORD.EXE. This inventory of software packages translates to a monetization of the software asset information. That is, if the organization is able to identify an underutilized software package, it can remove such unused copies of the software and realize a monetary savings. It is more difficult and time consuming, if not impossible, to realize, for example, license compliance and underutilization issues, through the identification of only software executable files.

Therefore, there is a need in the art for a method and apparatus for readily identifying and cataloging software assets and especially software packages installed on client computers and machines.

### SUMMARY OF THE INVENTION

Generally, a method and apparatus are disclosed for identifying and cataloging software packages and maintaining and updating a master catalog file of such collected information.

In one embodiment, there is provided a method for identifying software packages installed on a computer in a computer network. The method comprises: providing a searchable data base having a catalog file comprising a software items attributes table and software packages attributes table; uploading at least one software item entry installed on the computer to the catalog file; mapping the at least one software item entry to the software items attributes table to identify the at least one software item entry; mapping the identified at least one software item entry to the software packages attributes table; and analyzing the mapping results to identify at least one software package entry installed on the computer based upon the identified at least one software item entry.

### BRIEF DESCRIPTION OF THE DRAWINGS

A more complete understanding of embodiments of the present invention, as well as further features and advantages, will be obtained by reference to the following detailed description, which makes reference to the accompanying drawings, in which:

FIG. 1 is a block diagram of a computer network environment that operates in accordance with an embodiment of the present invention;

FIG. 2 is a top level functional block diagram illustrating the transfer of data during deployment of a master and custom catalog using the computer network of FIG. 1;

FIG. 3 is a functional block diagram of the data trace of the content resolution function of FIG. 2 in accordance with an embodiment of the present invention;

FIG. 4 is a functional block diagram illustrating the generation of a software asset catalog in accordance with an embodiment of the present invention;

FIG. 5 is a software item identification decision tree in accordance with an embodiment of the present invention;

FIG. 6 is the software item identification decision tree of FIG. 5 with one branching layer collapsed in accordance with an embodiment of the present invention;

FIG. 7 depicts a predetermined cascading order of branching layers collapsing and logical matching configurations as a function of accuracy and flexibility in accordance with an embodiment of the present invention;

FIGS. 8A and 8B are functional block diagrams for determining software package relationships in accordance with an embodiment of the present invention;

FIGS. 9A and 9B are functional block diagrams for determining software package relationships in accordance with an embodiment of the present invention;

FIG. 10 is a functional block diagram of a multilevel determination of software package relationships in accordance with an embodiment of the present invention; and

FIG. 11 is a depiction of an implied package-to-package relationship from the results of the determination made in connection with FIG. 10.

While embodiments of the present invention are described herein by way of example using several embodiments and illustrative drawings, those skilled in the art will recognize that the present invention is not limited to the embodiments or drawings described. It should be understood the drawings and detailed description thereto are not intended to limit the present invention to the particular form disclosed, but to the contrary, the present invention is to cover all modification, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

As used herein, the term “software item” means a universal software executable file, e.g., WINWORD.EXE. The term “software item entry” is a specific instance of a software item installed on a particular computer or machine. Also, the term “software package (or product)” means a collection of one or more member software items for specific application purposes. The term “software package entry” means a specific instance of a software package installed on a particular computer or machine.

### DETAILED DESCRIPTION

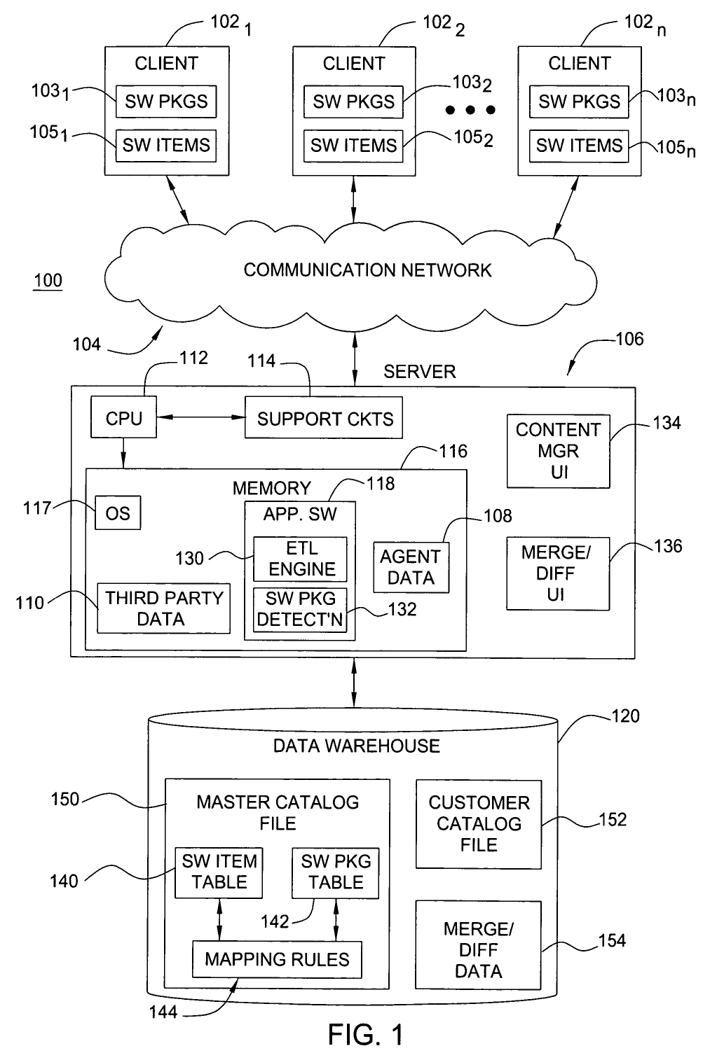

FIG. 1 depicts a computer network environment 100 in which embodiments of the present invention may be utilized. Embodiments of the present invention, as discussed below, include methods and apparatus for identifying and cataloging software items and software packages as well as identifying software item entries and software package entries found on a machine by machine basis in a computer network.

The computer network environment 100 comprises a plurality of networked client computers 102₁, 102₂ . . . 102ₙ connected via a network 104 to a server 106. The client computers 102₁₋ₙ may contain one or more individual computers, wireless devices, personal digital assistants, desktop computers, laptop computers or any other digital device or machine that may benefit from connection to a networked environment. Each client computers 102₁₋ₙ may also contain software package entries 103₁, 103₂ . . . 103ₙ, to be identified and catalogued. These software package entries may include software item entries 105₁, 105₂ . . . 105ₙ to be identified and catalogued for ultimately determining the software package entries contained on each machine.

The computer network 104 is a conventional computer network, which may be an Ethernet network, local area network (LAN), wide area network (WAN), a fiber channel network, and the like. The client computers 102₁₋ₙ may be connected to a server 106 through a firewall, a router, or some form of software switch (not shown).

The server 106 may generally comprise multiple servers. For simplicity, only one server is shown in FIG. 1, although those skilled in the art will realize many servers benefiting from embodiments of the present invention can be connected to the computer network 104. The server 106 generally includes at least one central processing unit (CPU) 112, support circuits 114 and memory 116. The CPU 112 may include one or more commercially available processors. The support circuits 114 are well known circuits that include cache, power supplies, clocks, input/output interface circuitry, and the like.

The memory 116 may include random access memory, read only memory, removable disk memory, flash memory, and various combinations of these types of memory storage. The memory 116 may sometimes be referred to as main memory and may in part be used as cache memory. This particular memory 116 includes agent data 108 and third party data 110, which is further described herein below. Similarly, the memory 116 stores various applications such as application software 118 and operating system software 117. The server 106 also comprises the content manager UI 134 and the merge/diff UI 136.

The server 106 is also coupled to a storage volume or data warehouse 120 that contains the master catalog data file 150, the customer catalog data file 152 and the merge/diff data file 154. The master catalog data file 150 comprises a software items table of attributes 140, a software packages table of attributes 142 and a mapping rules data base 144. The application software 118 in the server main memory 116 comprises an ETL engine 130 and a software package detection engine 132.

In accordance with an aspect of the present invention, IT asset information is initially collected from the enterprise network of computers through the ETL engine or agent 130 and stored in the agent data base 108. This data may eventually be used to populate the master catalog file 150. Third party data may also be provided and stored in the third party data base 110 for later use.

One method for collecting, storing and managing certain IT asset information for storage in the agent data base 108 is made possible by technology available from Blazent, Inc. of San Mateo, Calif. Examples of such methods and apparatus are described in commonly assigned U.S. Pat. No. 6,782,350 B1, issued Aug. 24, 2004, entitled “Method and Apparatus for Managing Resources,” the entire disclosure of which is incorporated by reference herein.

Generally, a software program (agent) is installed on the organization's network server(s), client computers and/or other IT devices where IT asset information is desired. Such information is obtained from substantially every IT device and peripheral connected to the enterprise's computer network(s). For example, the aforementioned Blazent agent technology obtains an inventory of IT computer hardware and software assets and provides information to the server 106, and the like. The agent then gathers this information into the agent data base 108 for later access and use.

The content manager UI 134 (discussed in detail herein) is employed in an embodiment of the present invention to assist a user in populating a master catalog 150 and customer catalog 152 in the first instance and in subsequent occurrences. The content manager UI 134 is also employed for importing and exporting the master and customer catalogs during customer deployment. The content manager UI 134 allows a user to see relationships between software items and software packages in order to be able to initially create the master catalog 150 and customer catalog 152. Certain information is imported from the agent data base 108 and a third party data base 110 and loaded into the content manager UI 134.

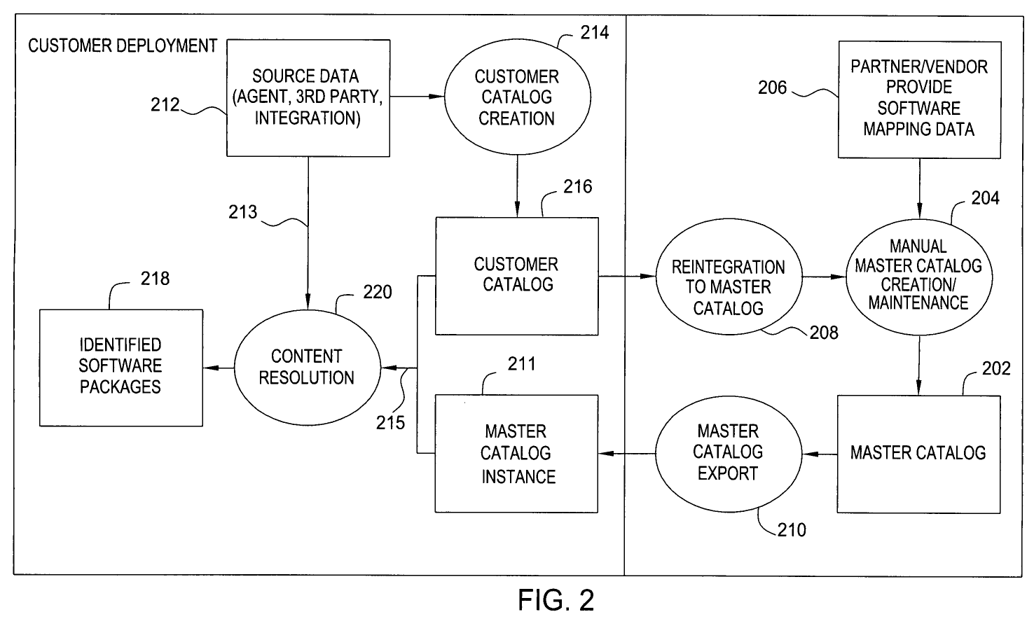

After data is loaded, the content manager UI 134 provides a set of software items and packages with entry level accuracy. A user, with the aid of the content manager UI 134 then reviews the software items and packages and determines the relationships among them to eventually produce an accurate list of software items and packages. In addition, the content manager UI searches for and determines the software package identifiers or keystone software items to be used later for identifying software package entries. The content manager UI 134 then creates a software item table 140 and a software package table 142 and mapping rules 144 and stores this information in the master catalog 150 for later deployment, as described in FIG. 2. In an embodiment, the master catalog 150 and customer catalog 152 are loaded as XML files for ease of deployment but are stored as relational data bases so the information can be accessed and sorted.

After the above process has been performed at least once, the content manager UI can give the user access to a base mapping of the networked computers. Then, in an embodiment, a user reviews the initial catalog of software items and packages for errors and duplications. Essentially, the user obtains an outlier list. In addition, the user initiates the merger/diff UI 136 and reviews the results to correct errors and remove duplication. After the master catalog 150 is built and checked for errors and duplications, it is exported or deployed to the customer site.

FIG. 2 depicts an overview of the flow of data to and from a customer site during deployment. The content manager UI is made available at the customer site to view the recently created catalog and to determine if there are any modifications that need to be made. As discussed above with respect to FIG. 1, the master catalog 202 is populated and maintained at stage 204 using partner/vendor provided software mapping data 206 as well as customer retrieved data 208 during re-integration processes.

During the deployment, new software packages may be added to the master catalog 202 and already existing software packages may be updated. Any logical ambiguities will be resolved before storing the new software packages to the master catalog 202. Then, the master catalog 202 is exported to the customer at stage 210 in XML (or other portable format). At stage 214, the customer collects data from the agent or integrated third party data 212. Using the content manager UI, the user at the customer site can create a customer catalog 216 with customer specific applications (i.e., software packages) based on source data collected for that deployment. This customer catalog creation process may be similar to the creation of the master catalog 211.

The customer catalog 216 and master catalog 211 (after the re-integration process 208) are then resolved in the content resolution stage 220, which then identifies software packages 218. There are two inputs into the content resolution process 220. The first is a source data input 213 from a source data base 212 containing the software found on the network computers. The source data base 212 may contain software information from an agent, third party or any integration data. The software is a listing of machines associated with the executables on them. The data is presented in a format that can be processed.

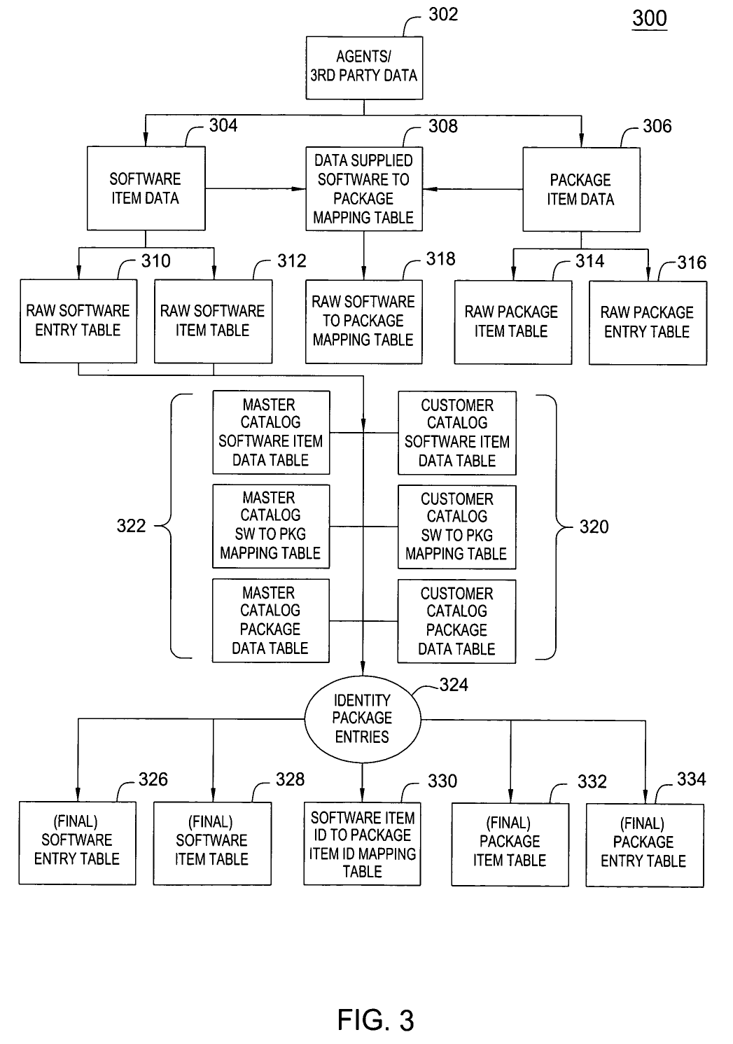

The second input 215 provides the catalog information from the customer catalog 216 and the master catalog 211. The content resolution process 220 processes the aforementioned information. The content resolution process thereby makes a determination as to what software products or packages are on each of the machines on the network being studied. This is depicted as an identified software package result 218. Further details of the flow of data with respect to the content resolution process 220 are discussed with respect to FIG. 3.

FIG. 3 depicts a data trace 300 of the content manager 220 showing the agent and third party source data 302 as it may be processed. The content resolution stage 206, in part, compares the source data 302 with the master catalog to determine how the two compare. Specifically, the software item data 304 includes a record of the association of the software executables to each machine. The software package item data 306 includes a record of the association of the package items to each machine. These two data records (software item data 304 and package item data 306) are combined to create a software package mapping table 308. This table feeds into a table including raw software to package mappings 318.

The software item data 304 is divided into a raw software entry table 310 and a raw software item table 312. The raw software item table 312 is the universal storage area. That is, as many software attributes are shared among many machines, not all that information has to be stored as a package entry. The software entries are the associations between the universal software items and the actual machines—the assets. This is what composes an entry. In other words, an entry is the association between the universal software items and the actual machines or assets. An entry is the association of an item to an asset—an installed software executable.

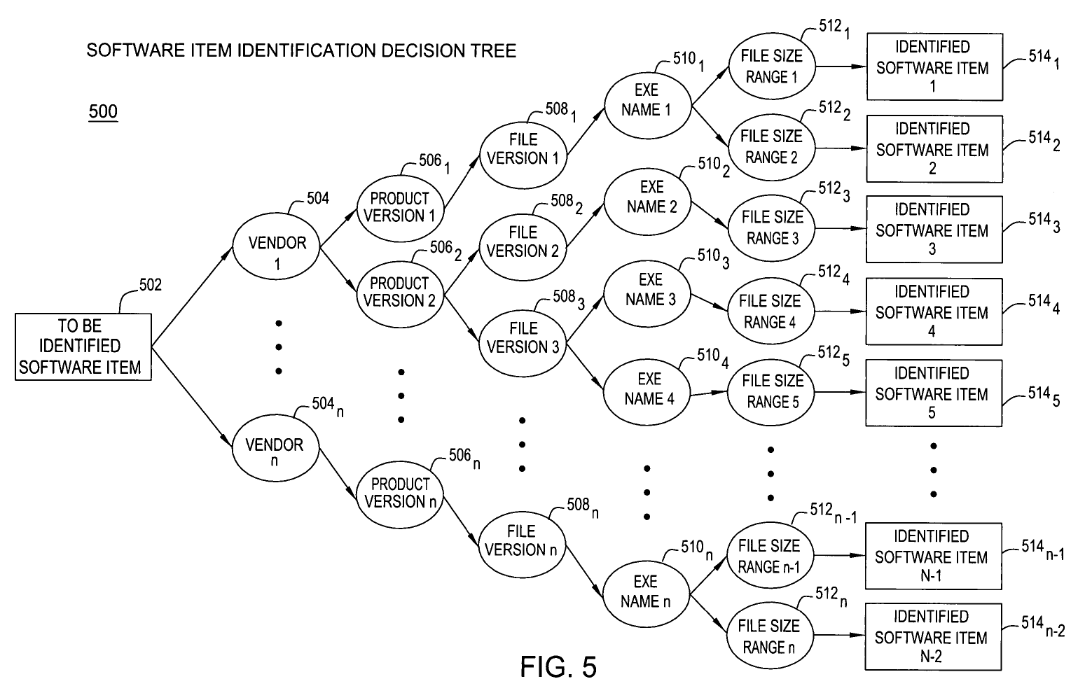

The software items and software entry tables are passed to the master catalog 322 or the customer catalog 320. In an embodiment, the two passes are made in serial. The first pass is with the customer catalog 320. The second pass is with the master catalog 322. Alternatively, the first pass may be made with the master catalog and the second with the customer catalog. From the received information, software attributes are compared and package entries are identified 324. Details of identifying package entries and generating the customer catalog 320 and the master catalog 322 are described in more detail in FIGS. 5 through 10.

A software package entry is the association between a software asset and a software package. Relationships are created between a software package and a software asset based on a software item 330. The process also stores the relationships that were created when determining the item/package relationship. So a user can observe what items match that made up a particular package. The data recorded at the “identify package entries stage” 324 are the final software entry table 326, the final software item table 328, the final package item table 332 and the final package entry table 334.

After performing both passes, the user identifies software packages that match up with the master catalog 322. Based on the entry (or asset) information, the system looks at an asset one by one in that machine's context. The definitions of mappings between items to software packages are taken. For example, WORD and EXCEL are mapped to OFFICE STANDARD and WORD, EXCEL and ACCESS are mapped to OFFICE PRO. On a machine, if there are only two software executables, the mapping will only pick that one package—OFFICE STANDARD. If there are three software executables, it will pick the other software package—OFFICE PRO. This is an important aspect about the machine context. If the software packages were looked at from the universal sense only, there would be no value provided. It is advantageous to actually group by software assets.

In one embodiment, this process is achieved through the use of a table structure and SQL query language commands. Fundamental principals of business intelligence make this process very efficient. Based on software item information, for example WORD and EXCEL, found on a particular machine, the user knows that in the master catalog, there is a mapping between identified WORD and EXCEL to an MS OFFICE product. Then, based on that rule in the master catalog, for this particular software asset, the OFFICE package exists on that machine. From that, a package item entry is created that associates that product with the assets.

One advantage in performing a mapping from software items to packages, instead of just going to a registry, is that in most licensing cases, if a file is copied over, then it would need a new license. For example, as depicted at the bottom of FIG. 3, package entries 334 associate the software packages with the software assets. The mapping tables are also created between those packages to their software assets. Thus, there is a relationship between the packages that are detected and the actual software items on that computer.

In this embodiment, the raw software entry table 310 and the final software entry table 326 are almost similar with minor cleansing performed. All software executables found on a particular software asset from the raw software entry information will be there. This relationship table 330 is created to tell the user exactly which rule is used from the master catalog to map and create the package entry.

When performing a licensing audit, for instance, through embodiments of the present invention, a user is able to go from a package to actual directories on that machine and show that, from the inventory of raw software package data, the user can actually see that this package is in fact installed. The output relationship table 330 creates the auditing capability to allow the user to drill down and see what software packages are on the machine for licensing purposes. Thus, the system looks at the entire hard drive, not just at the software program files.

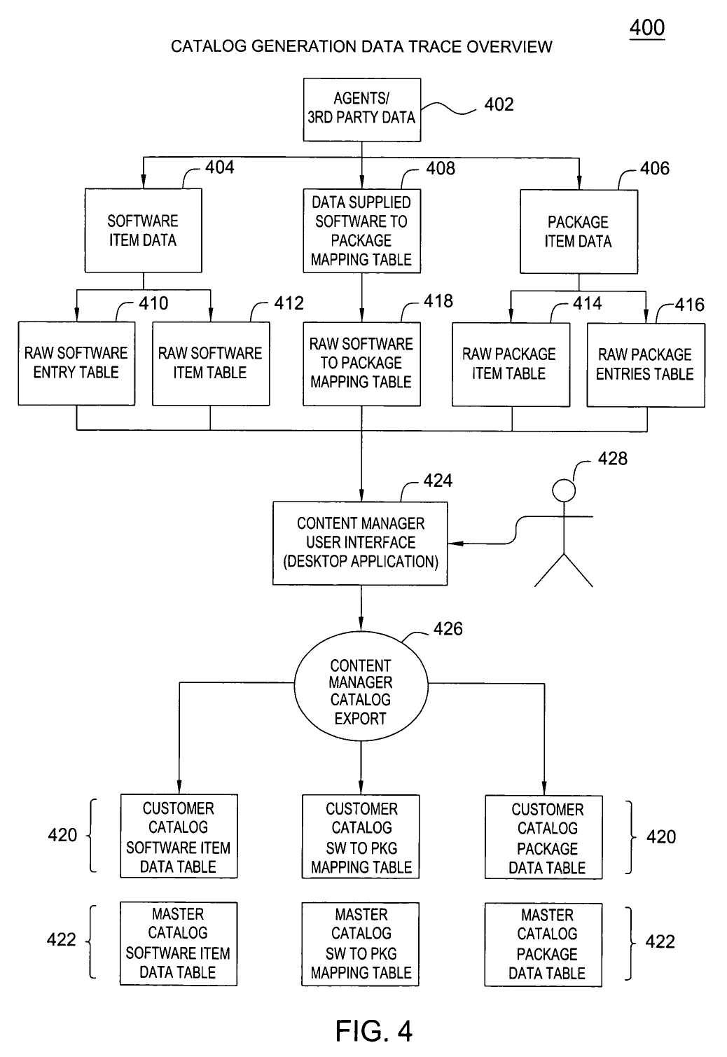

FIG. 4 details the catalog generation data trace 400. This is a trace of how raw software item data 404, software package data 406 and item to package mapping data 408 is processed by the content manager 424 and a user 428 to create a cleansed, useful customer catalog 420 and master catalog 422. At the initialization stage, there is no data in the customer catalog 420 or master catalog 422. In an embodiment, a user 428 may initially populate the master catalog. Initial relationships are created from the agent/3^{rd} party data 402 collected and stored in the server 106 (FIG. 1). The agent, as described previously, can assist in creating initial relationships between software items and software packages but not in a machine context.

The agent collects software asset information and begins to make relationships between software items and software packages. The user 428 then enters the information into the master catalog 422. The user 428 audits from a high level package standpoint to ensure that only licensable packages are included. In this regard, the user will exclude or remove packages that may be on a machine because of different versions, etc. Mapping is programmatically audited to make sure all software entries into the package entries are in a customer catalog.

The agent software runs through to all enterprise assets on the computer network 100 (FIG. 1). This gives a snap shot of full deployment of the computer network. The user 428, building the customer catalog 420, can look at the full deployment on the software asset level, software package level and see mappings automatically created, generate own mappings and create new fingerprints. All of this is happening at the content manager user interface (UI) 424.

The user may run SQL queries through the content manager UI 424 to assist the user with entering information. In an embodiment, the user may use the image machine from the customer deployment site and load the software contents from a software entry standpoint. At around the same time, the user may filter out unnecessary entries where attributes are not relevant.

Thus, in one embodiment, to generate a customer catalog, the content manager 424 loads data from the agent source 402. This includes software item data 404, package item data 406 and data supplied software to package mapping table 408. Then, the user 428, using the content manager UI 424 reviews the collected data, analyzes the data, cleanses where necessary and then populates the customer catalog. The process by which software item entries and software package entries are ultimately identified is described in connection with the remaining figures.

In accordance with another embodiment of the present invention, the above process may include at least one further step. In general, there is provided a final verification process during the generation of the catalog, which includes detecting a software package by comparing the final identified results with what was reported by the software vendor on the particular machine being examined, applying a mapping rule, and making a final decision. In other words, a catalog identified software package is evaluated with the collected software package entry information to determine if there is additional revision information.

As discussed herein, the system is capable of viewing raw software data, including software package information as reported by the agent source 402. This information may be collected from the operating system (OS) directly (via the registry on WINDOWS platforms and via the “pkgadd” mechanism on UNIX platforms). In the present application, the software packages that contain this information will be referred to as “OS Registered Software Packages.”

The saved information is obtained during a regular installation provided by the software vendors. This facilitates an uninstall process of the software at a later time and also for future upgrades to the software because the user can more easily determine whether it has an earlier version. This process also serves as a licensing mechanism at a basic level. The user collects this information as raw data on a machine by machine context. On occasion, software vendors may use this stored information to save more instance-specific licensing information such as registration keys or licensed user names. It is often the licenses registration key that makes a difference in terms of accountable license costs.

Certain enterprise software vendors bundle together multiple software products/packages into a single install and depending on the license key, different software products are made available to the user. This means the installed executables look the same everywhere but differ in licensing from machine to machine solely based on the license key that is stored with the install information. This is often the case where it is less expensive to simply ship the same install package for multiple licensable versions of a piece of software and then have the behavior of the software be determined by the license given to that specific instance.

As an example, a user might receive a generic MICROSOFT (MS) OFFICE install CD that contains both MS OFFICE STANDARD and MS OFFIC PRO editions. Everything copied over to the hard drive is the same every time on every machine. Then, MS distributes two license keys, one for MS OFFICE STANDARD edition and one for the MS OFFICE PRO edition. Typically, the IT manager will enter the license keys on two machines, one MS OFFICE STANDARD and the other MS OFFICE PRO. Both machines would have the same executables and directory structures but the software behaves differently because of the license key stored in the registries on each respective computer.

The above poses a problem to any system that has collected information based solely from executable data. This embodiment of the present invention addresses this problem. The system generates software package specific rules applied to the software package detection mechanism. Using the software package detection mechanism with the configurable decision trees as discussed herein, the system is able to identify those generic software package installs. However, because they are generic, more information is needed to specifically inform the user which version or edition a particular machine has installed. This information is found in the OS Registered Software Package information. The catalog will be aware of the different potentially licensable editions of a software package and will then look into the OS Register Software Package information collected by the agent source for that particular machine and determine the correct edition or version of the software package. That final edition or version specific software package is then recorded as being installed on that machine.

The user cannot merely record the OS Registered Software Package and skip the software package detection mechanism altogether because files can be copied over from machine to machine without the OS Register Software Package information. Granted, the software might not operate properly without the license key but when the software vendor performs an audit, it would still want to count the copied over files as an additional install. By performing the executable based software package detection, the user can identify the generic package installs so the end users are still able to see potentially licensable copies of software. By adding in the additional information provided by the software vendor via the OS Registered Software Packages, the user is able to detail more specific license information specific to each instance the traditional executable based package detection mechanism can not readily identify on its own.

The process by which these rules are generated is based on comparing the OS Registered Software Packages on a machine to the packages detected via the executable based package detection mechanism over multiple machine contexts. If the detection mechanism is not able to readily tell the difference between editions or versions, a set of rules is generated for that software package, each corresponding to a recorded distinct OS Registered Software Package. This is again, verified with the new rules and the catalog is then refined and ready to be deployed.

FIG. 5 depicts a decision tree 500 in accordance with an embodiment of the present invention for identifying software items. Identifying the software items is the initial step of several steps in determining the software package entries. As described with respect to FIG. 3, software items are “compared” to the master catalog or the customer catalog. For example, a software item (e.g. WINWORD.EXE) is provided as the subject software item in review. This software item is provided with a number of attributes that come in through one of the various collection integration agents.

After the catalogs have been populated, as described above, an initial inquiry with respect to the software item to be identified 502 is whether this software item compares to any software items in the customer catalog. If no match occurs, the next inquiry is whether this software item matches the master catalog. At this point, the system has collected the software item but is not looking at software item entries in the machine context yet. At this stage, the system is attempting to identify whether or not this software item matches with a software item that exists in the customer catalog or master catalog. In other words, it is comparing one software item with the entire table of customer catalog or master catalog software item data table (see FIG. 3).

In actual deployments, information about a file (the unknown software item to be identified 502) is often incomplete depending on its source and the mechanism in which it was collected. That is, depending on whether the software item information came from an agent or integration or a third party tool, sometimes all the information is not collected. In a separate instance, it may depend on the platform. For example, a UNIX-based system provides very little information about a software item compared to a non-UNIX based system regarding file version and manufacturing or vendor information. In another example, the master catalog may have been generated from a clean source that has all the information provided but the software item from the customer has little information. As a result, there will not be a complete match. Previous, known systems would end the inquiry and the software item would not be identified.

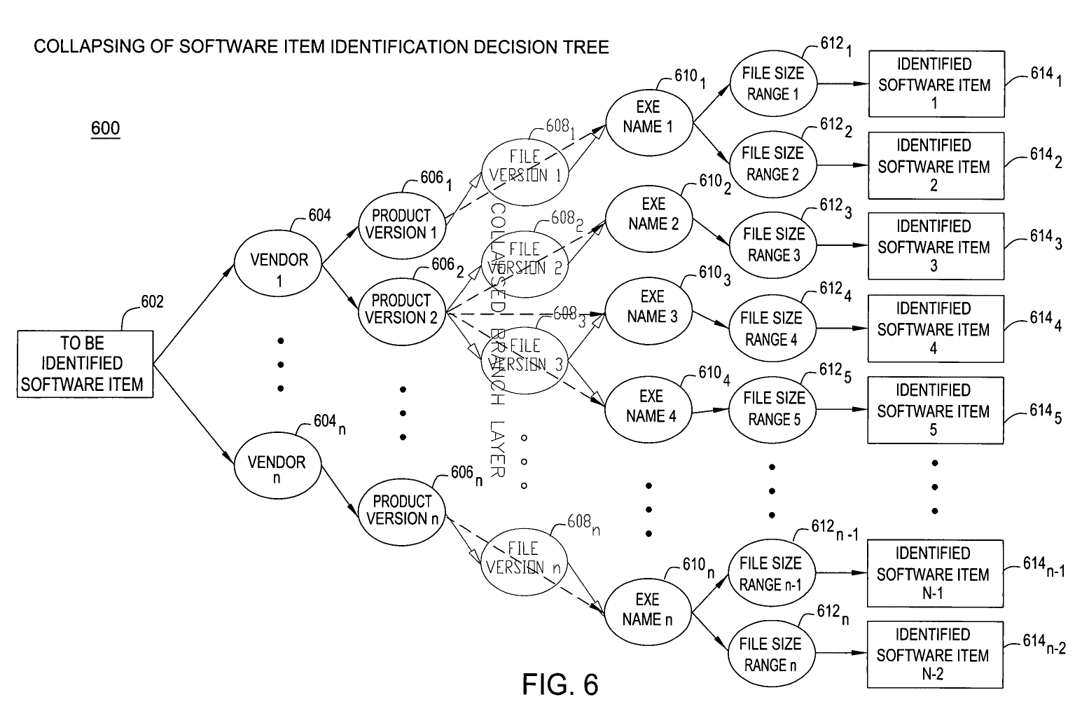

An advantage of an embodiment of the present invention is that, even though not all attributes are present (and therefore there no hard match), the system will still attempt to identify the software item as shown in connection with FIGS. 5 and 6. The process is flexible enough to deal with an unpredictable but familiar environment (i.e., not all but some information).

To deal with this unpredictable, yet familiar, environment, the catalog is treated as a configurable decision tree where each software item attribute type (e.g., executable name, file size, etc.) serves as a collapsible branching layer as shown in FIGS. 5 and 6. The data structure of the catalog allows for quick movement through, and manipulation of, this decision tree without complex node operations while achieving the same results. That is, when looking at the decision tree, all different layers of the tree are available. If a decision were to go down one layer (a collapsible branching layer), which is a representation of an attribute type (e.g., vendor), then all software items have that attribute. Whether or not the software item provides this information will determine if the branching layer is collapsed or not. A specific example is described in connection with FIG. 6.

With respect to FIG. 5, there is provided a software item to be identified 502. The first inquiry (first collapsible branching layer) on the decision tree relates to whether the software item includes a vendor attribute 504. Multiple attributes, like vendor attributes 504_{1-n,} are stored in the decision tree branching layers. For purposes of clarity, one row may be discussed at a time but it should be understood that this includes all possible entries in each branching layer.

The second inquiry (second collapsible branching layer) on the decision tree relates to product version 506. As shown in FIG. 5, each vendor 504 branches out into at least two product version rows 506₁ and 506₂. The third inquiry (third collapsible branching layer) on the decision tree relates to whether the software item includes a file version 508. The fourth inquiry (fourth collapsible branching layer) on the decision tree relates to whether the software item includes an executable name 510. The fifth inquiry (fifth collapsible branching layer) on the decision tree relates to whether the software item includes a file size range 512. If the raw software item 502 that was retrieved has been identified, then an identifiable version of it is included in the catalog.

The table data structure of the master catalog or customer catalog allows for relatively quick movement through and manipulation of this decision tree 500 without complex node operations while achieving the same results. In the table data structure, one row is stored for each one of these node paths. For example, the vendor MICROSOFT may be stored as a vendor multiple times for multiple software items. The SQL query language allows for a “group by” command and creates nodes and moves down the decision tree rather than having to perform an iteration each time. The catalog itself is a table but it is being treated as a decision tree.

The nodes along the path from the unknown software item 502 to the identified catalog entry 514 define the matching attributes that the software item and catalog entry 514 have in common. That is, for everything matched up to a point, there is a match and the branching layer does not collapse. When the unknown item 502 matches on an attribute layer, it drills down the decision tree, decreasing the search space and moves one step closer to potentially identifying the catalog item that this unknown item really is. That is, when the user looks at the decision tree, the user can see everything at the bottom (i.e., a larger search space). As the user moves down, the user sees less (i.e., smaller search space). The unfolding sequence of the tree primarily affects performance (fewer nodes may lead to relatively fast matches for instance) but does not affect the decision outcome. FIG. 5 is merely one embodiment of many decision trees contemplated by the present invention. The order of attributes in this embodiment is chosen because it provides for the minimum number of nodes.

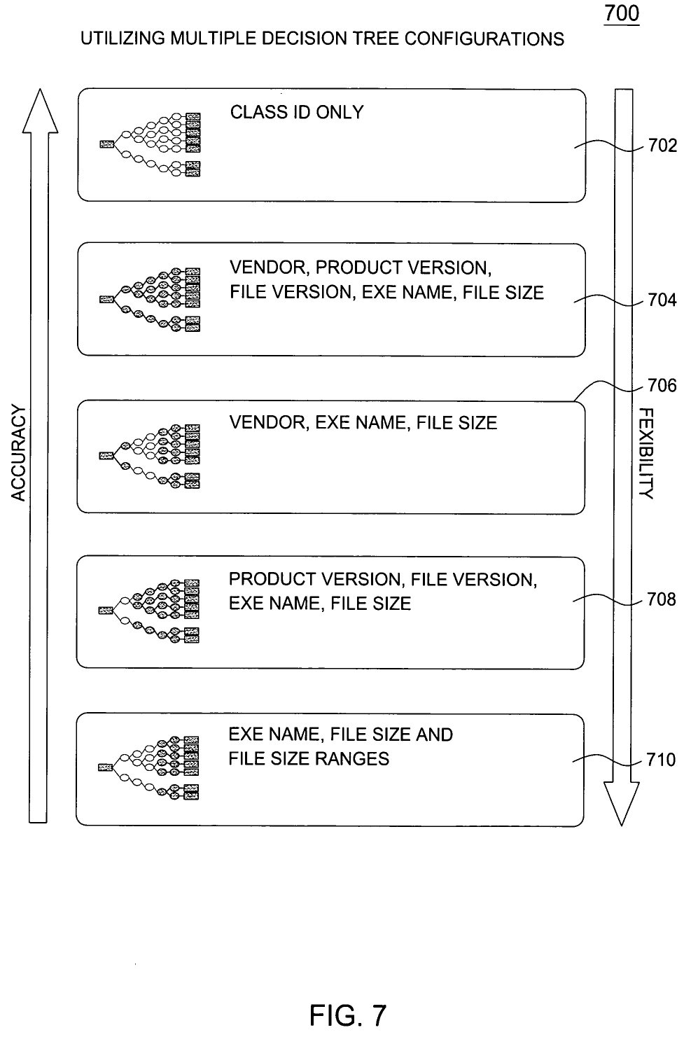

FIG. 6 depicts the decision tree of FIG. 5 showing a collapsed branching layer 608. The collapsing software item identification decision tree 600 is configurable to expose and collapse branching layers as needed. In other words, a set of attributes in the decision tree can be ignored if the information was not provided. In this example, the file version 608 is ignored. As such, that branching layer is collapsed because attribute information like file version of the unknown software item in question may be missing or incomplete. For those missing attributes, the branching layers are collapsed and the associated attributes are ignored. Multiple branching layers may be collapsed, if necessary, as shown in FIG. 7.

Another way of expressing the above process is to consider the collapsing of the branching layers like postponing a decision until a later juncture while not rejecting the unknown item in question completely. For example, if the customer does not have file version 608 information, this branch layer is collapsed and the inquiry moves to the executable name 610 and file size range 612 nodes.

To collapse a branch layer, each node in the collapsing branch assigns its child nodes to its parent node so there is now a direct path from the parent node to the children. For example, in FIG. 6, when the file vendor branching layer 608 is collapsed, all the executable name nodes 610 are assigned to respective product version nodes 606. As shown, file version 2 (608₂) and 3 (608₃) are collapsed, which are children of product version 2 (606₂). Now product version 2 inherits all of the children—executable names 2 (610₂), 3 (610₃) and 4 (610₄).

Specifically, for product version 2, there are three possible software items. Product version 2 is in three separate entry rows in the data base. File version 2 has one descendant and therefore one row. File version 3 has two descendants, so it has two rows. When the column is removed, the tree still has three rows—product version to software. If an SQL “group by” inquiry is made, which removes those columns from the select statement, product version 2 and these three files are left.

An ambiguous tree may exist when two or more nodes share the same node-path (excluding the nodes themselves). For example, this situation would occur when a user does not run a check to see if there are truly distinct rows in the data base. In this situation, a tie-breaker is needed to make a final determination. This tie-breaker function can simply reject the unknown item (i.e., if there is a tie, no identification). Alternatively, the system might call upon statistical data to determine which path is more reliable from past matches.

This tie breaker function is open ended—customized according to the needs of the user. To maximize accuracy, it is most ideal to have a fully unambiguous tree when all attribute layers are used (exposed). It is possible for ambiguity to occur when layers are collapsed. The tie breaker is a mathematical function. The input to the tie breaker function is a list of software items and attributes.

The reason for tie breaker functionality is when the user collapses branching layers of decision trees, most of the time, ambiguities will occur simply because of the catalog is not as complete when an attribute is removed. For example, if the file size, file name and file version are known, and the catalog includes a WORD.EXE file (file size 740 Kbytes, version 9.0) and a WORD.EXE file (file 740 Kbytes, version 8) and the customer does not provide the file version, then there is an ambiguity (i.e., WORD.EXE 740 Kbytes each). In one embodiment, the user will be prompted as to whether it wishes to have a determination made or whether, based on the one that the system chooses, which has been more statistically proven to happen in deployment, to match it or not.

FIG. 7 depicts a way of utilizing multiple decision tree configurations. This diagram 700 discusses a set of configuration hierarchy. Using this hierarchy, a user can perform a rigid or flexible match and all degrees in between. The more information available, the more rigid and thus more accurate based upon the Bayesian theory of statistical analysis.

In an embodiment, as depicted in FIG. 7, there are five different steps performed in order to arrive at identifying the software item. A user may perform multiple passes using the decision trees of FIGS. 5 and 6 through this particular hierarchy. Specifically, the decision tree will show and hide, expose and collapse different branch layers according to what was seen as performing the best in maintaining accuracy. For the layers shown, file size and executable name 710 are the minimum used to determine software items.

The simplest and most rigid identification of an unknown software item against the catalog is the “class identification only” pass (Class ID) 702. Any agent collected software item should have a Class ID signature (e.g., MD5 Hash) that almost universally identifies that software executable file. If the Class ID signature of the unknown software item exists in the catalog, then identification confidence is very high. There would be virtually no need to look at other attributes. However, there is almost no flexibility with this query.

Before the user can find the ability to turn on/off, depending on which SQL statement is used, for a particular software item, the data might be homogenous—some data is reported from UNIX and other data from PC's. PC's gives a lot more information than UNIX based systems. A user will perform a software sweep of any statement that has as much information as possible. This is why there is the hierarchy—cascading logic. For instance, if both agent collected information and other third party information is available, the first level of analysis is the Class ID through an MD5 hash, software executable.

If agent collected software item data is collected, all of the other attribute layers can be bypassed because the Class ID 702 is the software item identification. Therefore, the first step is to search for Class ID 702. If found, there are no nodes to hop through. For example, if a software item identification has been found, it will map to a catalog software item identification and the analysis is complete.

In operation, there is provided a large base of software items that need to be identified. The first inquiry is to see if a subset of those software items has Class ID's. If so, the next step is to check to see if any match with the master catalog. If so, then these software items are identified. This may be performed by the ETL engine 130. The decision tree is the catalog (see FIGS. 3 and 4). FIG. 3 has the master catalog software item data table or customer catalog software item data table. These two blocks are detailed in FIGS. 5 and 6.

Now, if no match is found on the Class ID (MD5 hash), then the next pass 704 searches for vendor, product version, file version, executable name and file size. Still considered to be strong matching configuration, this decision tree looks at all five attributes. Match confidence is high here because of the amount of detail required to pass through this decision tree successfully. This inquiry works well with agent data of new versions of a software package. Here, there is no need to look at the Class ID because it was searched for before in a previous pass. If everything matches in this pass, the software item can be identified as well.

If there is no match, then the next pass 706 removes file version and product version and looks for vendor, executable name and file size. This is a medium strength matching configuration looking at all attributes except product version and file version. Vendor information has proven to be more accurate than product version information when attempting to match items that were missed from previous passes and therefore is searched before the product version.

If there is no match, the next pass 708 removes vendor and searches for product version, file version, executable name and file size. This is weaker because only numbers are compared and not necessarily accurate. This is a medium to weaker strength matching configuration, ignoring vendor information. After the previous pass, largely executables with limited amounts of information are left that are difficult to narrow down. Still, version information does provide a high level of granularity and items that belong to different products with same file versions and sizes are highly uncommon.

Finally, the next pass 710, which could be split into two depending on what the user needs, includes file ranges. This pass is most flexible because file range allows you to branch out. At this pass, the user is left with data not able to be identified with the first four passes. This configuration can be broken down into two sub-configurations when considering whether to use file size ranges. In either case, this is the weakest but most flexible matching configuration. The file size range, when used, is particularly powerful at picking up software executable files that are modified on install with varying sizes.

In another embodiment, the user can turn these branches on and off. Users can create a new configuration. For example, if the user knows that no Class ID information exists, then the user can turn this layer off. Having this order allows the user to deal with homogenous data. As software items come in with varying amounts of attributes, the system will adapt.

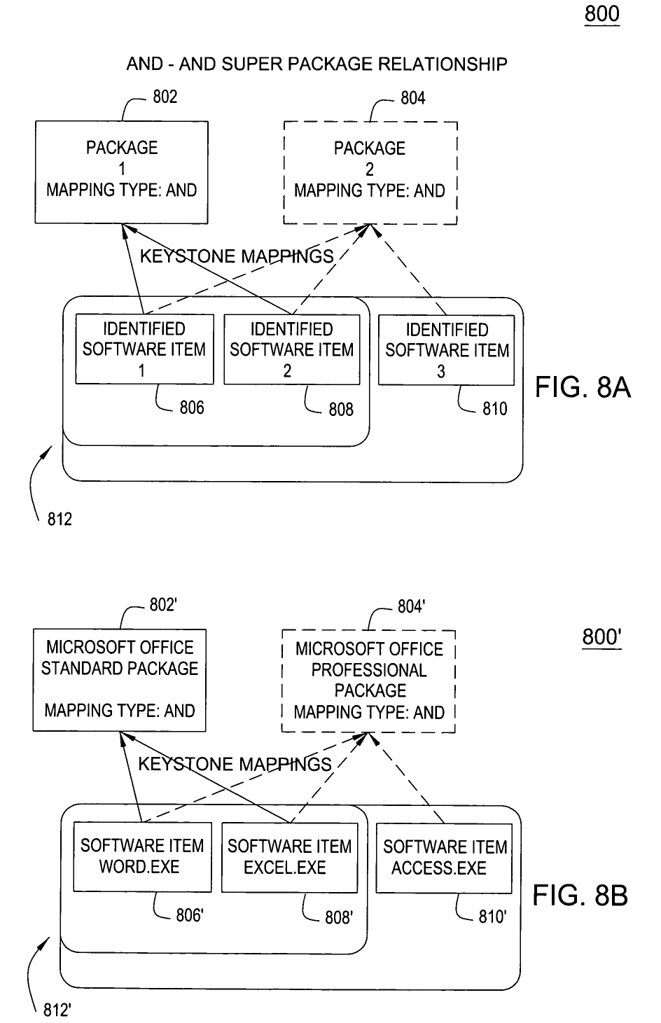

The above discussion relates primarily to identifying software items. The following discussion relates to the identification of super package entries and relationships. At this point in the process, the user has a broad set of software items related to the software items in the catalog. Now, that information is used to determine to which software packages those identified software items belong. FIGS. 8-11 describe how this is accomplished in accordance with embodiments of the present invention.

FIG. 8A is directed to an AND-AND super package relationship 800. For example, there are two software items 806 and 808 (identified software items 1 and 2) mapped on one machine 812. In this set up, both software items 806 and 808 have to be there for the two packages 802 and 804, respectively (i.e., package 1 and package 2) to exist. The existence of both of these software items on one machine can imply that package 1 exists on that machine. Package 1 is the child and package 2 is the super package. But, the existence of all three software items (806, 808 and 810) on the machine 812 can only imply that package 2 exists on that machine. From a technical standpoint, package 1 does exist by definition on the machine 812 but from a licensing standpoint, it is more useful to be able to determine that the super package (package 2) exists because this is the package that will require a license.

Specifically, package 1 is defined as an AND mapping of keystone software items 1 and 2. Package 2 is defined as an AND mapping of keystone software items 1, 2 and 3. Package 2 is considered a super package of package 1 because the keystone software items that define package 2 are a superset of the keystone software items that define package 1. Consider a machine with only software item 1 and 2 installed. Using this item-to-package mapping tree, only package 1 can be implied. A machine with software items 1, 2 and 3 could potentially imply package 1 and package 2 but because the definition of package 2 is a superset of the definition of package 1, package 2 is the only package that can be implied from this tree.

A package is considered the child of a super (or parent) package when a sub-set of the defining keystone software items of the super package can imply the child package. Because the software items mapped to package 1 are a subset of the items mapped to package 2, package 2 is a super package of package 1. This super package relationship is implied by keystone mapping definitions rather than explicitly specified in another structure or mechanism. By creating these relationships implicitly, the user is given greater power to do more complex package-to-package relationships and maintain a clean data structure that is best suited for business intelligence environment. So, when a user knows the relationship between the child package and the super package, in this example, the user can remove package 1 and leave package 2.

FIG. 8B is directed to a similar AND-AND super package relationship 800 but depicting a specific example using commercially available software items and packages. In the specific example, WORD.EXE and EXCEL.EXE are mapped to the OFFICE STANDARD package as keystone software items. They are also mapped to the OFFICE PRO package along with ACCESS.EXE. Because WORD.EXE and EXCEL.EXE are subsets of the OFFICE PRO package and the (WORD.EXE and EXCEL.EXE) set defines the OFFICE STANDARD package, OFFICE PRO is considered a super package of OFFICE STANDARD.

The existence of WORD.EXE and EXCEL.EXE on a machine is enough to imply that OFFICE STANDARD is installed. But, the existence of WORD.EXE, EXCEL.EXE and ACCESS.EXE on a machine should only imply that OFFICE PRO is installed on that machine. From a technical standpoint, the components that make up OFFICE STANDARD exist on that machine but from a licensing standpoint, the user only needs to identify that OFFICE PRO installed on that machine.

The package detection process, in accordance with this embodiment of the present invention, is aware of the super package relationship and will make sure that if the super package exists on a machine, all of its child packages should not. This is true because OFFICE STANDARD and OFFICE PRO should be mutually exclusive with respect to a licensable asset. When shown in an analysis report, this structure lends itself to easier visibility into the underlying definition of a package from a product standpoint. The user can immediately drill from the package to the items that compose that package, eliminating any expensive recursion down a package-to-package hierarchy. In this case, the user can drill straight from OFFICE PRO to WORD.EXE, EXCEL.EXE and ACCESS.EXE.

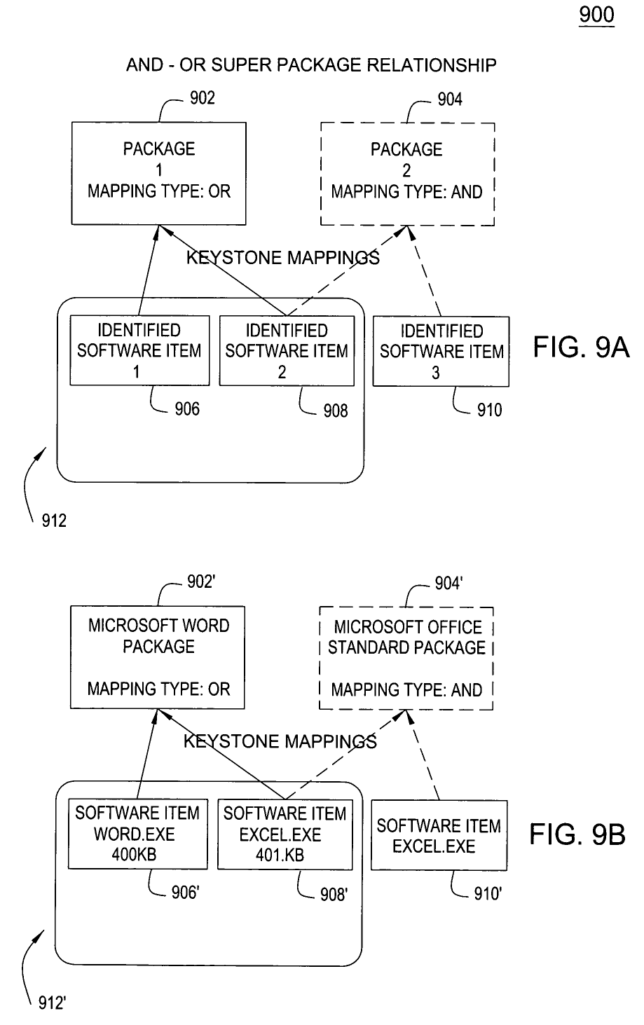

FIG. 9A is directed to an AND-OR super package relationship 900. Here, if any of the software items are mapped to one machine, then that application exists. Package 1 (902) is defined as an OR mapping of software items 1 (906) and 2 (908). Package 2 (904) is defined as an AND mapping of software items 2 (908) and 3 (910). When package 1 is defined as an OR mapping, all of the keystone mapped software items are effectively considered the same item. This is equivalent to saying package 1 exists if software item 1 OR software item 2 exists. This further implies if software item 1 exists, then package 1 exists. Software items 1 and 2 are logically equivalent.

As with respect to FIGS. 8A and 8B, in the AND-OR super package relationship 900, a package is considered a child of a super package when a sub-set of the defining keystone software items of the super package can imply the child package. For this reason, package 2 (904) is considered a super package of package 1 (902). Software item 2 (908) is a sub-set of the definition of package 2 (904) and is also the definition of package 1 (902). Package 2 can have any one of the mapped keystone software items of package 1 for package 2 to be a super package of package 1. An AND package mapped to software items 1 (906) and 3 (910) is logically equivalent to an AND package mapping of items 2 (908) and 3 (910).

In an embodiment of the present invention, the process effectively converts all packages that have multiple OR mapped software items to AND packages with one consolidated keystone software item. This optimizes performance as everything can now be treated as an AND type package in the catalog. Consider a machine with only software item 1 (906) or 2 (908) installed. Only package 1 (902) can be implied. A machine with software item 1 (906) and 3 (910) could imply package 1 and package 2 but because the definition of package 1 is an OR relationship, all of the keystone items are logically equivalent. Hence, the definition of package 2 is a superset of the definition of package 1. Package 2 is the only package that can be implied.

The two software items are logically the same software item. During the package detection and identification process, these OR'd software items logically equate into a single software item. This means if a software item matches software item 2, it will be considered software item 1 during package detection and identification because software item 1 is all that is required to imply that package 1 exists. Super package relationships are created when the to-be super package mappings contain any one of the OR'd software items of the child package. Specifically, if software item 1 OR software item 2 exist, then Package 1 exists. Package 2 is an AND type package. It only has software items 2 and 3 mapped to it. If software item 2 and software item 3 are present, then it can be implied that package 2 exists.

As stated before, package 2 is a super package of package 1. It does not matter if package 2 is mapped to software item 2 or software item 1. For example, wherever there is a software item 2, it can be replaced it with software item 1. Now there is just one software item to be concerned with. For the user creating the catalog, when the user wants to create a package 2 as a super package of package 1, the user can pick any one of the many software items. Software item 3 is the only necessary item that needs to be included.

FIG. 9B is directed to a specific example. There may be hundreds of different variations for the WORD.EXE software executable (e.g., file size, typographical errors in the manufacture field, etc.). For example, one software item WORD.EXE may have a file size of 400 Kbytes (906′) and the other 401 Kbytes (908′). The user can bring all variations into the catalog definition of the MS WORD 902′ package and create OR relationships for all of them. This means if any of those various item definitions are found, one can infer that the MS WORD package exists on that machine. This mapping will effectively consolidate all of the variations of WORD.EXE into one item. Now, when the user wants to create a super package OFFICE STANDARD 904′, the user can pick any of the WORD.EXE's mapped to the MS WORD package because they all mean the same thing. That is, they all imply the MS WORD package 902′.

There can be multiple versions of the WORD.EXE executable with varying attributes for the same product (major product release). In order to catch all of these variations, the user can create software item rules with the different attributes in the catalog and map them as OR relationships to the MS WORD 902′ package. During the package detection process, these OR'd software items logically equate into a single software item. This abstracts all of the various WORD.EXE definitions into one logical high level WORD.EXE at the product level.

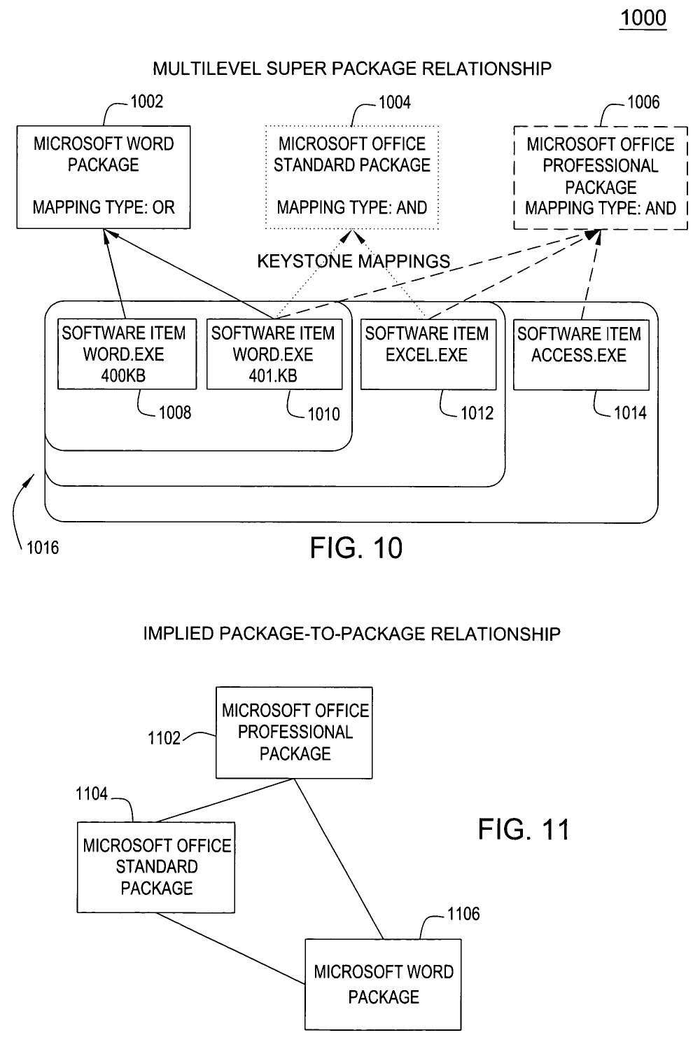

FIG. 10 is directed to a multilevel super package relationship 1000. It depicts a combination of the configurations of FIGS. 8B and 9B. MS OFFICE STANDARD packages and MS WORD software items are removed for licensing purposes. If there are any ambiguities in the packages, the user reviews the content manager and deletes where necessary.

Variations of WORD.EXE items can imply the existence of the MS WORD package. The existence of WORD.EXE (any variation in that equated logical set) and EXCEL.EXE and imply the existence of the MS OFFICE STANDARD package. The existence of WORD.EXE (any variation in that equated logical set), EXCEL.EXE AND ACCESS.EXE imply the existence of the MS OFFICE PRO package.

FIG. 11 depicts an implied package-to-package relationship. Based on the mapping tree above between packages and software items, the user can create this implied package-to-package relationship tree. MS OFFICE PRO is a super package to MS OFFICE STANDARD AND MS WORD because both child packages follow the original definition of a child package. That is, a package is considered the child of a super package when a sub-set of the defining keystone software items of the super package can imply the child package.

Because the user is using all the definitions of the packages to create package-to-package relationships, this allows for many-to-many, package-to-package relationships. MS WORD has two super packages (or parents) and can easily have more. The need to create a tertiary many-to-many, package-to-package mapping data structure while keeping the existing data structure optimized for drilling in analytics is minimized. The process to explicitly build this tree is also optimized by the logical equating of OR mapped software items.

In accordance with embodiments of the present invention, the existence of a software package on a client computer or other hardware equipment does not require the presence of all of the software package's existing member software items. Rather, the presence of just one or a few specific “signature” or “keystone” software files is necessary to identify the software package and give the unique characteristics of the software package. While many non-key files in a software package may be common or even shared with other software packages, the key file(s) are usually unique to a specific software package. It is the unique presentation of the key files that identify a software package. In other words, the same key file may exist in multiple packages but the combination of unique keys makes the package unique.

Embodiments of the present invention allow mapping of a particular software item to multiple packages, if necessary. Components are shared. Only a few of the software items really truly identify that particular software package. For instance, WINDOWS 2000 always has EXPLORER.EXE. If the client computer does not contain EXPLORER.EXE, it does not have a fully installed WINDOWS 2000 software package. Similarly, with MS OFFICE, if the client computer does not have WINWORD.EXE and EXCEL.EXE, then the client computer does not contain the entire product. The rest of the software items are unnecessary for purposes of identifying a software package on a client computer. By finding the key or signature software items, one can identity one or more software packages.

As another example, suppose a query is made as to whether a particular client computer has standard MS OFFICE or MS OFFICE PRO. A user would know that if the client computer has WINWORD.EXE, EXCEL.EXE, PPOINT.EXE and ACCESS.EXE, then it has the MS OFFICE PRO software package. If it does not have ACCESS.EXE, then the client computer only has the standard MS OFFICE. To achieve this, the system mapped four executables (software items) to two different software packages. Three software items mapped to two software packages and one software item mapped to one. So using key software items, the system only needed to map four software item entries instead of, for example, four hundred. By identifying ACCESS.EXE, the system identified MS OFFICE PRO.

While the foregoing is directed to one embodiment of the present invention, other and further embodiments of the invention may be devised without departing from the basic scope thereof, and the scope thereof is determined by the claims that follow.

What is claimed is:

1. A method for identifying software packages installed on a computer in a computer network, comprising:
(a) providing a searchable data base having a catalog file comprising a software items attributes table and software packages attributes table;
(b) uploading at least one software item entry installed on the computer to the catalog file;
(c) mapping the at least one software item entry to the software items attributes table to identify the at least one software item entry;
(d) mapping the identified at least one software item entry to the software packages attributes table; and
(e) analyzing the mapping results to identify at least one software package entry installed on the computer based upon the identified at least one software item entry.

2. The method of claim 1, wherein step (e) is performed using a decision tree.

3. The method of claim 2, wherein the decision tree comprises collapsible branching layers.

4. The method of claim 2, wherein the decision tree comprises a hierarchical mapping.

5. The method of claim 4, wherein the hierarchical mapping comprises comparing the class ID of the at least one software item entry with class ID's of software items in the software items attributes table.

6. The method of claim 5, wherein the class ID is an MD5 hash.

7. The method of claim 6, wherein, if the at least one software item entry does not include a class ID, then the hierarchical mapping comprises comparing the vendor, product version, file version, executable name and file size attributes of the at least one software entry with the software items attributes table.

8. The method of claim 7, wherein if the software item entry does not include any one of the vendor, product version, file version, executable name or file size attributes, then the hierarchical mapping comprises comparing the vendor, executable name and file size attributes of the at least one software entry with the software items attributes table.

9. The method of claim 8, wherein if the software item entry does not include any one of the vendor, executable name or file size attributes, then the hierarchical mapping comprises comparing the product version, file version, executable name and file size attributes of the at least one software entry with the software items attributes table.

10. The method of claim 9, wherein if the software item entry does not include any one of the product version, file version, executable name or file size attributes, then the hierarchical mapping comprises comparing the executable name, file size and file size range attributes of the at least one software entry with the software items attributes table.

11. The method of claim 10, wherein if a software item match is not made, then the method further comprises:
(f) setting a threshold range of software item attribute values; and
(g) mapping the at least one software item entry to the threshold range of software item attribute values.

12. The method of claim 11, wherein if step (g) does not yield a match, then the method further comprises:
(h) verifying the at least one software item entry; and
(i) adding the at least one software item entry to the catalog file.

13. The method of claim 1, wherein if the at least one software item entry matches a software item attribute from the software items attributes table, then step (e) further comprises:
(f) mapping the identified at least one software item entry to a software package.

14. The method of claim 13, wherein at least three identified software item entries are mapped using AND-AND logic to identify a software package entry and a super software package entry.

15. The method of claim 13, wherein at least three identified software item entries are mapped using AND-OR logic to identify a software package entry and a super software package entry.

16. The method of claim 13, wherein at least four identified software item entries are mapped using OR-AND-AND logic to identify a multilevel super package entry.

17. A computer-readable medium having stored thereon a plurality of instructions, the plurality of instructions including instructions which, when executed by a processor, cause the processor to perform the steps of a method for identifying software packages installed on a computer in a computer network, comprising:
(a) providing a searchable data base having a catalog file comprising a software items attributes table and software packages attributes table;
(b) uploading at least one software item entry installed on the computer to the catalog file;
(c) mapping the at least one software item entry to the software items attributes table to identify the at least one software item entry;
(d) mapping the identified at least one software item entry to the software packages attributes table; and
(e) analyzing the mapping results to identify at least one software package entry installed on the computer based upon the identified at least one software item entry.

18. The computer-readable medium of claim 17, wherein step (e) is performed using a decision tree having collapsible branching layers.

19. The computer-readable medium of claim 18, wherein the decision tree comprises a hierarchical mapping.

20. A system for identifying software packages installed on a computer in a computer network, comprising:
means for providing a searchable data base having a catalog file comprising a software items attributes table and software packages attributes table;
means for uploading at least one software item entry installed on the computer to the catalog file;
means for mapping the at least one software item entry to the software items attributes table to identify the at least one software item entry;
means for mapping the identified at least one software item entry to the software packages attributes table; and
means for analyzing the mapping results to identify at least one software package entry installed on the computer based upon the identified at least one software item entry.

21. The method of claim 13, further comprising:
evaluating the identified software package in view of information reported by a software vendor on the computer;
applying additional mapping rules corresponding to reported information; and
verifying the identified software package.

22. The method of claim 21, wherein the evaluation step comprises evaluating a catalog identified software package with the collected software package entry information to determine additional revision information.

23. The method of claim 21, wherein the reported information comprises OS Registered Software Packages information.

24. The method of claim 23, wherein the additional mapping rules correspond to the recorded distinct OS Registered Software Package information for the computer.
